(19) United States
(12) Patent Application Publication
(10) Pub. No.: US 2006/0054093 A1
(43) Pub. Date: Mar. 16, 2006

(54) PORTABLE DRIP-TYPE WATER BOTTLE STAND FOR PETS

(76) Inventor: Preston Shaffer, Exeter, NH (US)

Correspondence Address: MESMER & DELEAULT, PLLC, 1 NEW HAMPSHIRE AVE., SUITE 125, PORTSMOUTH, NH, 03801, US

(21) Appl. No.: 10/711,345

(22) Filed: Sep. 13, 2004

(51) Int. Cl. A01K 7/00

(52) U.S. Cl. 119/72

(57) ABSTRACT

A portable water bottle system for pets including a cylindrical water bottle having a drip tube that terminates at a point outside a zone defined by the water bottle cylinder extended to the length of the drip tube, and a water bottle stand, the water bottle stand including a base portion, and a holder portion having a top end, a bottom end, and an internal cavity at least large enough to support the water bottle, the bottom end secured perpendicular to the base portion, and the top end having a slot at least as wide as a water bottle extending longitudinally along the holder portion and terminating above the bottom end.

### BACKGROUND

1. Field of the Invention

The invention is related to drip-type water bottles for animals.

2. Description of the Related Art

Pet owners are responsible for making sure that their pets have adequate water. For pets that are traveling or kept in cages, the primary watering system has been a cylindrical water bottle with a drip tube that is bent in the middle. The bend and the length of the drip tube are design so that the water bottle can be secured to the outside of a cage with the drip tube protruding downward into the cage where it is accessible to the pet. The pet learns that licking the drip tube will release some of the water in the bottle.

There are many situations, however, where this arrangement is inadequate. For example, if the cage is no longer available, if the pet is being displayed at a show, or if the pet refuses to enter the cage, the water bottle attached to a cage will not be useful. What is needed, therefore, is a system for supporting a water bottle for pets with its drip tube downward that does not require a cage.

### SUMMARY

A system for supporting a water bottle for pets with its drip tube downward that does not require a cage is a stand comprising a base portion and a holder portion having a top end, bottom end, and an internal cavity at least large enough to support a water bottle, the bottom end secured substantially perpendicularly to the base portion, and the top end having a slot extending longitudinally along the holder portion and terminating above the bottom end at least as wide as a water bottle drip tube. These and other features, aspects, and advantages of the present invention will become better understood with regard to the following description, claims, and accompanying drawing.

### DRAWING

FIG. 1 is a perspective view of the stand and system according to the present invention.

### DESCRIPTION

The invention is a system for supporting a water bottle for pets with its drip tube downward that does not require a cage is a stand comprising a base portion and a holder portion having a top end, bottom end, and an internal cavity at least large enough to support a water bottle, the bottom end secured substantially perpendicularly to the base portion, and the top end having a slot extending longitudinally along the holder portion and terminating above the bottom end at least as wide as a water bottle drip tube.

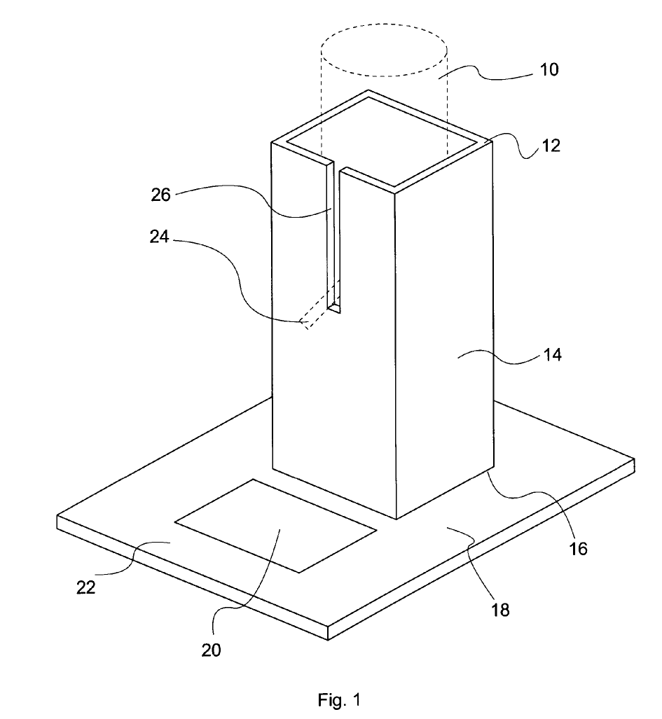

Turning to FIG. 1, the stand has two main components. The holder portion 14 has an internal cavity that has a clearance at least large enough to support a water bottle 10. It may have a round cross section, or a regular polygon cross section. The preferred embodiment, which is shown, uses a square cross section. The holder portion 14 has a top end 12, a bottom end 16, and a slot 26 extending from longitudinally along the holder portion and terminating above the bottom end 16. It has been discovered that a good termination point is three inches above the bottom end 16. The slot 26 is at least as wide as the water bottle drip tube 24 it is designed to support.

The holder portion 14 is secured substantially perpendicularly to a base portion 18. The base portion 14 is preferably rectangular. The purpose of the base portion 18 is to keep the water bottle 10 and holder portion 14 from tipping over. Therefore, it has been discovered that the base portion 14 should extend beyond the holder portion by at least 50% of the width of the holder portion in each direction.

An optional feature of the invention is to include a drip catcher container 20 for catching drips from the drip tube 24. If the drip catcher container 20 option is used, then the one end of the base portion 18 should be elongated to form an elongated end 22. The elongated end 22 should extend beyond the holder portion 14 by at least 75% of the width of the holder potion 14.

Another optional feature is a handle, which is not shown. A tee handle or loop handle are preferred.

The stand and system according to the present invention are designed to work with a standard, round, animal water bottle 10. A drip tube 24 is secured to a water bottle 10 opening. The drip tube 24 is bent in the middle. The end of the drip tube terminates at a point outside a zone projected by the water bottle cylinder to the length of the drip tube 24. In this way, the bottle 10 can be mounted outside of a cage, with the drip tube 24 protruding inside the cage, as is done in the prior art.

In the present invention, a user places a water bottle 10 with the drip tube 24 down into the holder portion 14 such that the drip tube 24 protrudes through the slot 26. The size of the internal cavity of the holder portion 14 should be only slightly larger than the water bottle 10, but the cavity can be larger. As the water bottle 10 slides down the holder portion 14 cavity, it is stopped by the drip tube 24 contacting the bottom of the slot 26. Preferably, the termination point of the drip tube 24 should be at a height above the base portion 18 that is comfortable for a pet to access.

While there have been described what are at present considered to be the preferred embodiments of this invention, it will be obvious to those skilled in the art that various changes and modifications may be made therein without departing from the invention, and it is, therefore, aimed to cover all such changes and modifications as fall within the true spirit and scope of the invention.

What is claimed is:

1. A stand for supporting a water bottle with a drip tube for pets comprising
a base portion, and
a holder portion having a top end, a bottom end, and an internal cavity at least large enough to support a water bottle, the bottom end secured substantially perpendicularly to the base portion, and the top end having a slot extending longitudinally along the holder portion and terminating above the bottom end at least as wide as a water bottle drip tube.

2. The stand of claim 1, wherein the holder portion has a substantially square cross-section, and the internal cavity has a clearance at least as large the diameter of a cylindrical water bottle.

3. The stand of claim 1, wherein the base portion is substantially rectangular and extends beyond the holder portion by at least 50% of the width of the holder portion.

4. The stand of claim 3, the base portion further comprising an elongated end extending beyond the holder portion by at least 75% of the width of the holder portion.

5. The stand of claim 4, further comprising a drip catcher container.

6. The stand of claim 1, wherein the holder portion has a cross section that is round

7. The stand of claim 1, wherein the holder portion has a cross section that is regular polygon.

8. The stand of claim 7, wherein the holder portion has a cross section that is square.

9. The stand of claim 1, further comprising a handle attached to the holder portion.

10. A portable water bottle system for pets comprising
a cylindrical water bottle having a drip tube that terminates at a point outside a zone defined by the water bottle cylinder extended to the length of the drip tube, and
a water bottle stand, the water bottle stand comprising
a base portion, and
a holder portion having a top end, a bottom end, and an internal cavity at least large enough to support the water bottle, the bottom end secured substantially perpendicularly to the base portion, and the top end having a slot at least as wide as a water bottle extending longitudinally along the holder portion and terminating above the bottom end.

11. The system of claim 10, wherein the holder portion has a substantially square cross-section, and the internal cavity has a clearance at least as large the diameter of a cylindrical water bottle.

12. The system of claim 10, wherein the base portion is substantially rectangular and extends beyond the holder portion by at least 50% of the width of the holder portion.

13. The system of claim 12, the base portion further comprising an elongated end extending beyond the holder portion by at least 75% of the width of the holder portion.

14. The system of claim 13, further comprising a drip catcher container.

15. The system of claim 10, wherein the holder portion has a cross section that is round.

16. The system of claim 10, wherein the holder portion has a cross section that is a regular polygon.

17. The system of claim 16, wherein the holder portion has a cross section that is square.

18. The system of claim 10, further comprising a handle attached to the holder portion.
